(19) United States
(12) Patent Application Publication
(10) Pub. No.: US 2008/0007793 A1
(43) Pub. Date: Jan. 10, 2008

(54) System and method to limit the use of the outgoing facsimile feature of a multi-function peripheral (MFP) to a list of valid destinations

(76) Inventors: Walter Filbrich, Manhattan Beach, CA (US); Steve Livengood, Laguna Niguel, CA (US); Brian Podl, Newport Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/483,066

(22) Filed: Jul. 6, 2006

(51) Int. Cl. H04N 1/00

(52) U.S. Cl. 358/440

(57) ABSTRACT

A system and method for sending data via facsimile at a multi-function peripheral (MFP) with a facsimile capability are disclosed. In one aspect, the method of sending data via facsimile comprises receiving a document, receiving via an input interface a destination phone number which identifies the destination to which the document is to be facsimiled, receiving a request via the input interface to send the document via facsimile at a scheduled time, checking one or more predetermined conditions that the request has to satisfy to pass a security check based on the received destination phone number and/or the scheduled time, and sending the document via facsimile as requested if the one or more predetermined conditions are met.

### BACKGROUND OF THE INVENTION

1. Field of the Invention

The invention relates to the operation of a device with a facsimile capability. More particularly, the invention relates to limiting the use of the outgoing facsimile feature of such a device.

2. Description of the Related Technology

Existing security features of devices with a facsimile capability such as multi-function peripherals (MFPs) require each user to log into the device with an authorized name and password. Once logged in, the user has access to all capabilities of the device, including the capability to send fax transmissions to any remote device. This opens a security gap since there is no control over the destination of the transmission. Moreover, existing security features complicate the operation by requiring a logon for all transmissions, even those known to be sent to a valid, secure destination. Therefore, it is desirable to introduce new features into devices with a facsimile capability which can provide security for fax transmission while offering flexibility when the device is used in a workgroup environment.

### SUMMARY OF CERTAIN INVENTIVE ASPECTS

The system, method, and devices of the invention each have several aspects, no single one of which is solely responsible for its desirable attributes. Without limiting the scope of this invention, its more prominent features will now be discussed briefly.

In one aspect, a method of sending data via facsimile at a multi-function peripheral (MFP) with a facsimile capability comprises receiving a document, receiving via an input interface a destination phone number which identifies the destination to which the document is to be facsimiled, receiving a request via the input interface to send the document via facsimile at a scheduled time, checking one or more predetermined conditions that the request has to satisfy to pass a security check based on the received destination phone number and/or the scheduled time, and sending the document via facsimile as requested if the one or more predetermined conditions are met.

In another aspect, a method of configuring a multi-function peripheral (MFP) with a facsimile capability comprises receiving authentication data, logging in to a secure mode of the device based on the authentication data, and receiving a list of valid destination identifiers identifying destinations to which a facsimile is allowed to be sent and storing the list at the device while the device is in the secure mode.

In another aspect, a multi-function peripheral (MFP) with a facsimile capability comprises an input interface for receiving data from a user, a display for providing information to the user, a storage device for saving data comprising user account information and at least one of: a list of valid destination phone numbers and a list of valid time intervals during which a facsimile is allowed to be sent, and a processor executing software applications to control the input interface and the display to realize user interaction and to save and retrieve data to and from the storage device, wherein the processor is configured to i) check a request to send a facsimile to a destination at a scheduled time against one or more predetermined conditions, the conditions being based on the scheduled time and/or a phone number received via the input interface identifying the destination, and ii) to deny the request if the request fails to meet one of the one or more predetermined conditions.

In another aspect, a multi-function peripheral (MFP) device with a facsimile capability comprises means for receiving a document, means for receiving via an input interface a destination phone number which identifies the destination to which the document is to be facsimiled, means for receiving a request via the input interface to send the document via facsimile at a scheduled time, means for checking one or more predetermined conditions that the request has to satisfy to pass a security check based on the received destination phone number and/or the scheduled time, and means for sending the document via facsimile as requested if the one or more predetermined conditions are met.

### BRIEF DESCRIPTION OF THE DRAWINGS

FIG. 1 is a block diagram illustrating one embodiment of a system in which a device with a facsimile capability is connected to multiple computers.

FIG. 2 is a block diagram illustrating one embodiment of the device 12 as illustrated in FIG. 1.

FIG. 3 is a flowchart of one embodiment of a method of sending data via facsimile at a device 12 with a facsimile capability as illustrated in FIG. 1.

FIG. 4 is a flowchart illustrating one embodiment of the process to check a request for fax transmission against one or more predetermined conditions shown as block 28 in FIG. 3.

FIG. 5 is a flowchart of one embodiment of a method of configuring a device 12 with a facsimile capability as illustrated in FIG. 1.

### DETAILED DESCRIPTION OF CERTAIN INVENTIVE EMBODIMENTS

Various aspects and features of the invention will become more fully apparent from the following description and appended claims taken in conjunction with the foregoing drawings. In the drawings, like reference numerals indicate identical or functionally similar elements. In the following description, specific details are given to provide a thorough understanding of the disclosed methods and apparatus. However, it will be understood by one of ordinary skill in the art that the disclosed methods and apparatus may be practiced without these specific details. For example, electrical components may be shown in block diagrams in order not to obscure certain aspects in unnecessary detail. In other instances, such components, other structures and techniques may be shown in detail to further explain certain aspects.

It is also noted that certain aspects may be described as a process, which is depicted as a flowchart, a flow diagram, a structure diagram, or a block diagram. Although a flowchart may describe the operations as a sequential process, many of the operations can be performed in parallel or concurrently and the process can be repeated. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

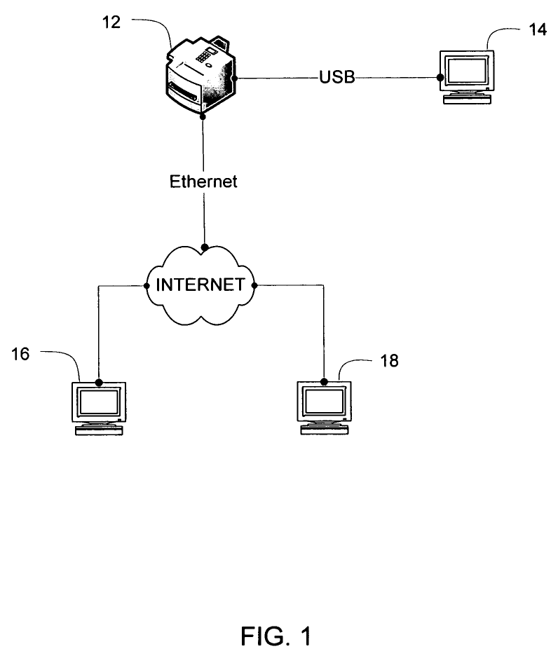

FIG. 1 is a block diagram illustrating one embodiment of a system in which a device with a facsimile (also referred to as fax below) capability is connected to multiple computers. The device 12 can be any suitable device having a facsimile capability. Some examples are a multi-function peripheral (MFP) having a facsimile capability and a traditional fax machine. A multi-function peripheral (MFP) refers to an equipment connectable to a PC or network that handles two or more of the following functions: printing, scanning, copying or faxing. A multi-function peripheral is also called a multi-function product, a multi-function printer, a multi-function device, and an All-in-One device etc.

In some applications, the device 12 needs to be connected to one or more computers for various purposes. In one embodiment, the device 12 is connected to a computer 14 via a wired connection such as a USB cable as shown in FIG. 1. In another embodiment, the device 12 is connected to a computer via a wireless connection (not illustrated). In still another embodiment, the device 12 is connected to a network, wired or wireless, to which multiple computers are connected. The network may be a local area network (LAN), wide area network (WAN), or the Internet, for example. In FIG. 1, the device 12 is connected to the Internet via an Ethernet connection. Two computers 16 and 18 are also connected to the Internet. In this way, the device 12 may receive any documents to be transmitted via fax from computers 16 and 18 via the Internet. Also, an authorized user may be able to set the security settings for the facsimile capability of the device 12 via the Internet.

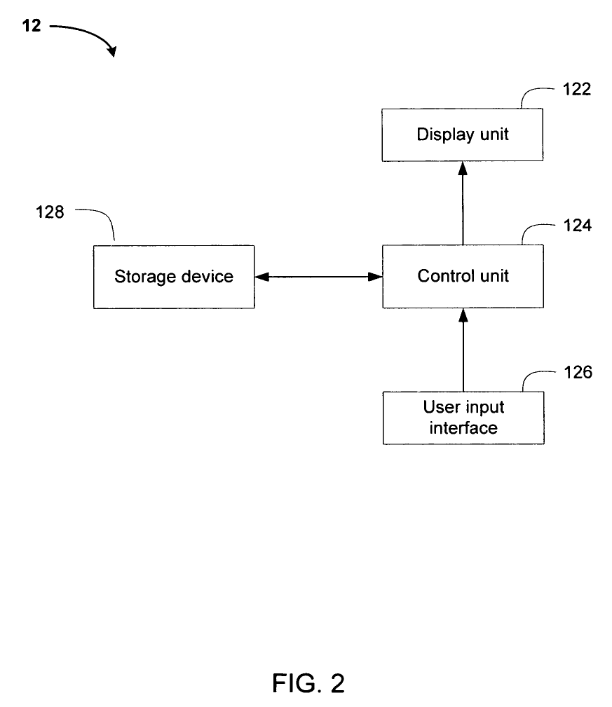

FIG. 2 is a block diagram illustrating one embodiment of the device 12 as illustrated in FIG. 1. In the exemplary embodiment, the device 12 comprises a display unit 122, a control unit 124, a user input interface 126, and a storage device 128.

The user input interface 126 and the display unit 122 are included to enable user interaction. The display unit 122 is used to communicate information, instructions, or data to a user. The user input interface 126 is configured to receive input data from a user such as a document to be faxed out and a phone number identifying the destination.

Both the display unit 122 and the user input interface 126 can be implemented in many forms and may contain multiple components. In one embodiment, the display unit 122 may be, for example, a LCD. The user input interface 126 may include a keypad or keyboard. The user input interface 126 may also include an interface compatible with a portable storage device provided by the user, such as a compact flash card, such that the device 12 can read data from the portable storage device via such an interface. In other embodiments, the user input interface 126 and the display unit 122 may be integrated together in one device such as a touch screen as incorporated in a panel of certain copy machines.

Both the display unit 122 and the user input interface 126 can be an integral part of, or an external device connected to, the device 12. In certain embodiments, both the display unit 122 and the user input interface 126 are connected to a computer which is connected to the device 12 through a communication link. The device 12 interacts with the user through the computer.

In the exemplary embodiment, the device 12 also includes a storage device 128 to store data, for example, certain settings limiting outgoing fax transmission and a software application which the control unit 124 runs to control the operation. The storage device 128 can be an integral part of, or an external device connected to, the device 12. In certain embodiments, the storage device 128 is configured to keep the data or its contents regardless if the power is turned off or if the storage device is moved to another computer. In one embodiment, the storage device 128 is an internal hard drive. In another embodiment, the storage device 128 can be any kind of flash storing media, for example, a compact flash card.

The control unit 124 controls the operation of the device 12. In one embodiment, the control unit 124 is a processor which may be any suitable general purpose single- or multi-chip microprocessor, or any suitable special purpose microprocessor such as a digital signal processor, microcontroller, or a programmable gate array. As is conventional, the processor may be configured to execute one or more software applications. In certain embodiments, the control unit 124 runs a software application in communication with the display unit 122, the user input interface 126, and the storage device 128, to realize user interaction and to save and retrieve data to and from the storage device.

In one embodiment, the processor is configured to i) check a request to send a facsimile to a destination at a scheduled time against one or more predetermined conditions, the conditions being based on the scheduled time and/or a phone number received via the input interface identifying the destination, and ii) to deny the request if the request fails to meet one of the one or more predetermined conditions.

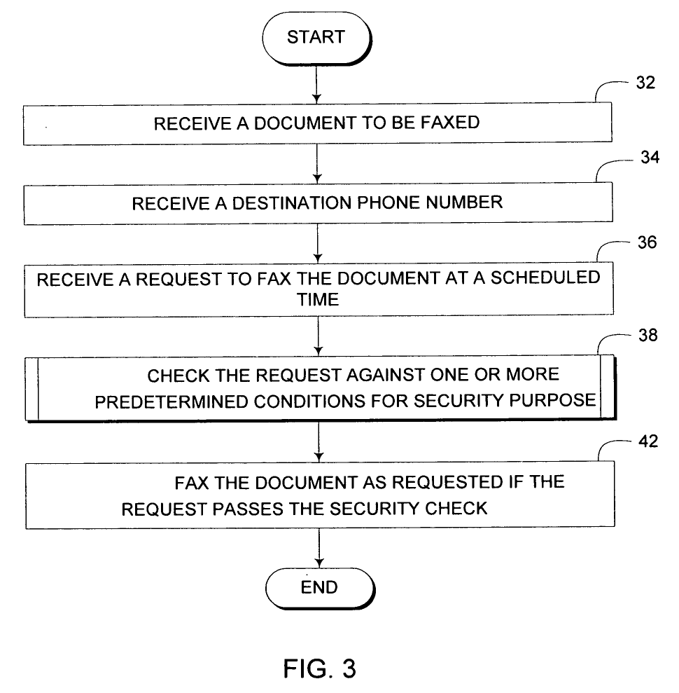

FIG. 3 is a flowchart of one embodiment of a method of sending data via facsimile at a device 12 with a facsimile capability as illustrated in FIG. 1. The exemplary method limits the use of the facsimile feature of a device with a facsimile capability, particularly its use for outgoing fax. One feature of the exemplary method is that it limits fax transmissions to a list of valid destinations, regardless of the login capabilities of the user, therefore providing an additional level of security for fax transmissions over the standard user authorization method commonly used. Another feature is that fax transmissions to valid destination may be made without requiring a logon.

The method begins at a block 32, where the device 12 receives a document to be faxed from a user. In one embodiment, the device 12 receives the document from a user via a user input interface 126 (see FIG. 2). Typically, that is when the user places a document on the device 12, such as in the feed tray or on a scanning platform. Alternatively, the device 12 may receive the document by reading a portable storage device provided by the user, such as a compact flash card, via the user input interface 126. In another embodiment, the device 12 may receive the document from a computer via a communication link.

Next at a block 34, the device 12 receives a destination phone number identifying the destination to which the document is to be facsimiled. In one embodiment, the device 12 receives the destination phone number via a user input interface 126. The user may input the destination phone number directly using a keypad. The user may also input the destination phone number by selecting a phone number from a list of phone numbers stored at the device 12. In another embodiment, the device 12 may receive the destination phone number via a communication link.

Moving to a block 36, the user receives a request to send the received document via facsimile at a scheduled time to the destination identified by the received phone number. In one embodiment, the device 12 receives the request via a user input interface 126. In another embodiment, the device 12 may receive the request via a communication link.

A user may request the document to be sent instantly or at a later time. If the request from the user does not specify a scheduled time explicitly, the device 12 may treat such a request as one to send the document via fax instantly subject to the availability of the device 13, i.e., a request to send the document at a scheduled time which is immediately after the request is received.

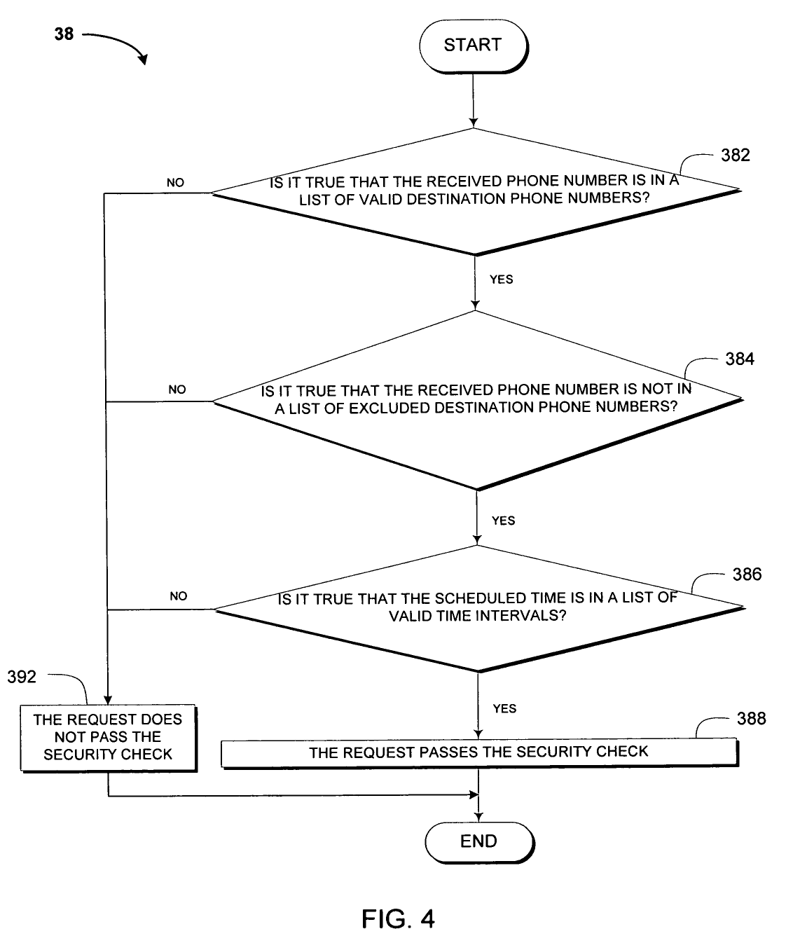

Next at a block 38, the device 12 checked the received request against one or more predetermined conditions for security purpose. These predetermined conditions are set by an authorized user and stored at the device 12. A request fails to pass the security check if the request fails to meet one of the predetermined conditions. block 28 will be described in detail below with reference to FIG. 4.

Then at a block 42, the device 12 sends out the document via fax as requested if the request passes the security check. In case the scheduled time is substantially later than the time the request is received, the device 12 will save the request and send the document later at the scheduled time. The device 12 will not send out the document as requested if the request fails to pass the security check.

FIG. 4 is a flowchart illustrating one embodiment of the process to check a request for fax transmission against one or more predetermined conditions shown as block 28 in FIG. In the exemplary embodiment, the device 312 checks a received request to send a document via fax against one or more predetermined conditions for the purpose of security check. These predetermined conditions are set by an authorized user and stored at the device 12. A request fails to pass the security check if the request fails to meet one of the predetermined conditions.

At a block 382, the device 12 checks whether the request meets a condition that the destination phone number is in a list of valid destination phone numbers. In one embodiment, the list of valid destination phone numbers may comprise an entry specifying a range identified by a first phone number and a last phone number. The destination phone number is determined to be in the list of valid destination phone numbers if it falls between the first and last phone number. If the device 12 finds that the request fails to meet the condition in block 382, the method then moves to a block 392 where the device concludes that the request fails to pass the security check.

The method moves to a block 384 if the device 12 finds that the request meets the condition in block 382. At block 384, the device 12 checks whether the request meets a condition that the destination phone number is not in a list of excluded destination phone numbers. In one embodiment, the list of excluded destination phone numbers may comprise an entry specifying a range identified by a first phone number and a last phone number. The destination phone number is determined to be in the list of excluded destination phone numbers if it falls between the first and last phone number. If the device 12 finds that the request fails to meet the condition in block 384, the method then moves to block 392 where the device concludes that the request fails to pass the security check. If the device 12 finds that the request meets the condition in block 384, the method then moves to a block 386.

Now at block 386, the device 12 checks whether the scheduled time is valid. In certain embodiments, the scheduled time is valid if the scheduled time to send the fax is in a list of valid time intervals during which users are allowed to make transmission by fax. In one embodiment, the device 12 may further require that the user is authorized to save a document for a later delivery via fax, if the scheduled time is substantially later than the time the request is received. In that embodiment, the scheduled time is valid only if both conditions are met. One way to check whether a user is authorized to save a document for a later delivery via fax is to request authentication data from the user and check the authentication data against a database stored at the device 12. The database can be created and updated by an authorized user to grant or deny users access to various features including saving a document for a later delivery via fax.

If the device 12 finds that the request fails to meet the condition in block 386, the device then moves to block 392 where the device concludes that the request fails to pass the security check. If the device 12 finds that the request meets the condition in block 386, the method then moves to a block 388 where the device concludes that the request passes the security check.

The exemplary embodiment comprises blocks 382, 384, and 386, each of which checks the request to send a document via fax against a different predetermined condition for the purpose of security check. The device 12 concludes that the request does not pass the security check if one of the conditions is not met. It will be appreciated that blocks 382, 384, and 386 can be rearranged in order without changing the function of this method. In certain embodiments, the method may comprise only one or two blocks out of blocks 382, 384, and 386.

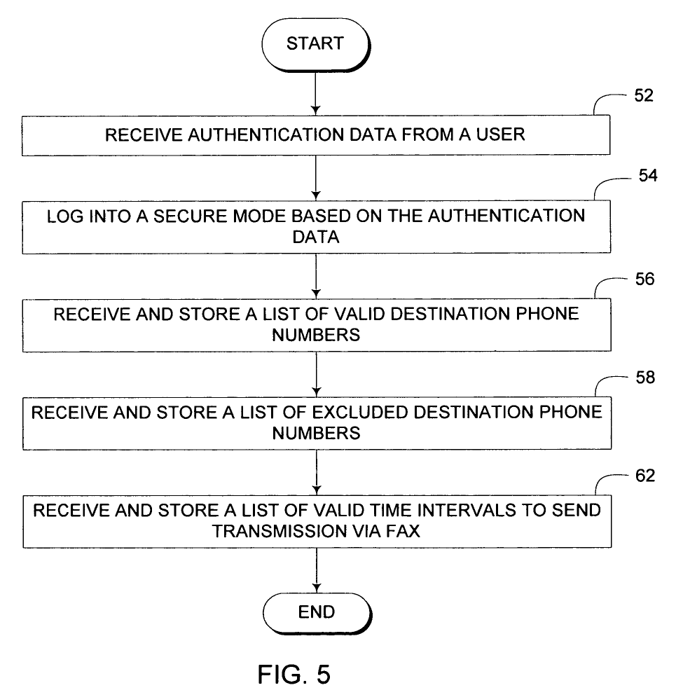

FIG. 5 is a flowchart of one embodiment of a method of configuring a device 12 with a facsimile capability as illustrated in FIG. 1. In the exemplary method, the device 12 receives data from an authorized user and stores the same, wherein the received data configures one or more predetermined conditions for purpose of security check as discussed above in FIG. 4.

The method starts at a block 52, where the device 12 receives authentication data from a user. In the exemplary embodiment, the authentication data may comprise a password or a PIN number. The authentication data may also comprise other information about the user including an identification code or number, for example, a username which conforms to a variation of a person's name.

In certain embodiments, the device 12 may receive the authentication data via the user input interface 126 (see FIG. 2). In one embodiment, the user input interface 126 is a keypad and the authentication data such as username and password can be entered using the keypad. In another embodiment, the user input interface 126 may include a special device which retrieves user authentication data by scanning a user identification card or biometric information and sends the data to the control unit 124.

In other embodiments, the device 12 may receive the authentication data via a communication link. In one embodiment, the device 12 is connected to the Internet as illustrated in FIG. 1. The user can enter the authentication data by using a remote management web tool which can be invoked by typing the device's IP address or hostname on a web browser such as Internet Explorer. Examples of the remote management web tool include Samsung's Web Sync Thru or like and any internal embedded web server of the device 12.

Moving to a block 54, the device 12 logs into a secure mode based on the received authentication data. The control unit 124 may contain a software application, which manages and maintains user profiles saved on the storage device 128. As discussed above, the storage device 128 may be integrated within the device 12 or attached to the device 12 remotely. In either case, the control unit 124 is in data communication with the storage device 128. By reading data stored at the storage device 128 such as user profile, the control unit 124 is able to check the received authentication data, and log into a secure mode if the received authentication data is correct. Once logging into the secure mode, the device is able to receive data from the user to update one or more predetermined conditions for the purpose of security check.

Next at a block 56, the device 12, while being in the secure mode, receives a list of valid destination phone numbers from the user and stores the same. As discussed before, if the transmission is valid over a range of phone numbers, such as within a department or company, the valid destinations may be entered by specifying a range of numbers defined by a first phone number and a last phone number.

Moving to a block 58, the device 12, while being in the secure mode, receives a list of excluded destination phone numbers from the user and stores the same.

Next at a block 62, the device 12, while being in the secure mode, receives a list of valid time intervals when fax transmissions can be made and stores the same. In one embodiment of the block 62, the device 12 may further receive data from the user to update a database stored at the device so as to grant or deny certain users' access to various features including saving a document for a later delivery via fax.

Similar to the above discussion in block 52, the device 12 may receive data via the user input interface 126 or via a communication link in blocks 56, 58, and 62.

The exemplary embodiment comprises blocks 56, 58, and 62, each of which is used to configure a different predetermined condition for the purpose of security check. It will be appreciated that blocks 56, 58, and 62 can be rearranged in order without changing the function of this method. In certain embodiments, the method may comprise only one or two blocks out of blocks 56, 58, and 62.

In certain embodiments, the device 12 with a facsimile capability supports the feature of sending fax transmission to an email box identified by an email address. Typically, the device 12 will convert the document into a PDF file and send the PDF file to the email box as an attachment. Embodiments of methods and systems discussed above can be easily applied herein since the only difference between these embodiments and the embodiments discussed above is that the destination of the fax transmission is now identified by an email address and/or a phone number instead of a phone number.

The foregoing description details certain embodiments of the invention. It will be appreciated, however, that no matter how detailed the foregoing appears in text, the invention can be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

What is claimed is:

1. A method of sending data via facsimile at a multi-function peripheral (MFP) with a facsimile capability, comprising:
receiving a document;
receiving, via an input interface, a destination phone number which identifies the destination to which the document is to be facsimiled;
receiving a request via the input interface to send the document via facsimile at a scheduled time;
checking one or more predetermined conditions that the request has to satisfy to pass a security check based on the received destination phone number and/or the scheduled time; and
sending the document via facsimile as requested if the one or more predetermined conditions are met.

2. The method of claim 1, wherein the one or more conditions comprises a first condition that the received destination phone number is in a list of valid destination phone numbers stored at the device.

3. The method of claim 1, wherein the one or more conditions comprises a first condition that the scheduled time is in a list of valid time intervals stored at the device.

4. The method of claim 2, wherein the one or more conditions further comprises a second condition that the scheduled time is in a list of valid time intervals stored at the device.

5. The method of claim 2, wherein the one or more conditions further comprises a second condition that the received destination phone number is not in a list of excluded destination phone numbers stored at the device.

6. The method of claim 2, further comprising:
receiving authentication data via the input interface; and
logging on a user to a user account based on the authentication data prior to sending the document.

7. The method of claim 2, wherein the document receiving comprises scanning the document.

8. The method of claim 2, wherein the request is to send the document instantly if no scheduled time is received.

9. The method of claim 2, wherein the scheduled time is immediately after the request is received.

10. The method of claim 6, wherein the one or more conditions further comprises a second condition that the user is authorized to send a document at a later time in case the scheduled time is substantially later than the time the request is received.

11. A method of configuring a multi-function peripheral (MFP) with a facsimile capability, comprising:
receiving authentication data;
logging in to a secure mode of the device based on the authentication data; and
receiving a list of valid destination identifiers identifying destinations to which a facsimile is allowed to be sent and storing the list at the device, while the device is in the secure mode.

12. The method of claim 11, further comprising receiving a list of valid time intervals during which a facsimile is allowed to be sent and storing the list of valid time intervals at the device.

13. The method of claim 11, further comprising receiving a list of excluded destination identifiers to which a facsimile is not allowed to be sent and storing the list of excluded destination identifiers at the device.

14. The method of claim 11, wherein each receiving is performed via a communication link.

15. The method of claim 14, wherein the communication link is a network connection established when the administrator accesses the device's embedded web server.

16. The method of claim 11, wherein the identifiers are phone numbers and/or email addresses.

17. The method of claim 13, wherein the identifiers are phone numbers and/or email addresses.

18. A multi-function peripheral (MFP) with a facsimile capability, comprising:
an input interface for receiving data from a user;
a display for providing information to the user;
a storage device for saving data comprising user account information and at least one of: a list of valid destination phone numbers and a list of valid time intervals during which a facsimile is allowed to be sent; and
a processor executing software applications to control the input interface and the display to realize user interaction and to save and retrieve data to and from the storage device,
wherein the processor is configured to i) check a request to send a facsimile to a destination at a scheduled time against one or more predetermined conditions, the conditions being based on the scheduled time and/or a phone number received via the input interface identifying the destination, and ii) to deny the request if the request fails to meet one of the one or more predetermined conditions.

19. The device of claim 18, wherein the one or more conditions comprises a first condition that the received destination phone number is in a list of valid destination phone numbers stored at the device.

20. The device of claim 18, wherein the one or more conditions comprises a first condition that the scheduled time is in a list of valid time intervals stored at the device.

21. The device of claim 19, wherein the one or more conditions further comprises a second condition that the scheduled time is in a list of valid time intervals stored at the device.

22. The device of claim 19, wherein the one or more conditions further comprises a second condition that the received destination phone number is not in a list of excluded destination phone numbers saved at the device.

23. The device of claim 19, wherein the storage device is configured to store data even when the storage device does not receive power.

24. The device of claim 19, wherein the display and the input interface are integrated in a single device.

25. A multi-function peripheral (MFP) device with a facsimile capability, comprising:
means for receiving a document;
means for receiving, via an input interface, a destination phone number which identifies the destination to which the document is to be facsimiled;
means for receiving a request via the input interface to send the document via facsimile at a scheduled time;
means for checking one or more predetermined conditions that the request has to satisfy to pass a security check based on the received destination phone number and/or the scheduled time; and
means for sending the document via facsimile as requested if the one or more predetermined conditions are met.

26. The device of claim 25, wherein the one or more conditions comprises a condition that the received destination phone number is in a list of valid destination phone numbers stored at the device.
